(19) United States
(12) Patent Application Publication
(10) Pub. No.: US 2026/0039669 A1
(43) Pub. Date: Feb. 5, 2026

(54) ELECTRONIC DEVICE AND METHOD FOR PROVIDING AN ALARM AND STORING A LOG ACCORDING TO DETECTING AN ATTACK ON A VEHICLE NETWORK

(71) Applicants: HYUNDAI MOTOR COMPANY, Seoul (KR); KIA CORPORATION, Seoul (KR)

(72) Inventor: Seung Yeon Jeong, Hwaseong-si (KR)

(73) Assignees: HYUNDAI MOTOR COMPANY, Seoul (KR); KIA CORPORATION, Seoul (KR)

(21) Appl. No.: 19/208,184

(22) Filed: May 14, 2025

(30) Foreign Application Priority Data
Aug. 2, 2024 (KR) 10-2024-0103028

(51) Int. Cl. H04L 9/40

(52) U.S. Cl. CPC H04L 63/1416; H04L 63/1425; H04L 63/1441

(57) ABSTRACT

A includes: detecting an attack on a vehicle network; when the attack is detected, determining whether the attack continues for a first period of time; when the attack continues for the first period of time, storing a log just before a second period of time; when the attack continues for the first period of time, providing an alarm; after the alarm, determining whether the attack continues for a third period of time; when the attack continues for the third period of time, providing the alarm again; when the attack does not continue for the third period of time, determining that the attack is ended; determining whether the end of the attack continues for a fourth period of time; and when it is determined that the attack is ended, storing a log from a time point, at which the attack is ended, to a fifth period of time.

### CROSS-REFERENCE TO RELATED APPLICATION

This application claims priority to and the benefit of Korean Patent Application No. 10-2024-0103028, filed on Aug. 2, 2024, the disclosure of which is incorporated herein by reference in its entirety.

### BACKGROUND

### 1. Technical Field

The present disclosure relates to a method and a device for providing an alarm and storing a log according to detecting an attack on a vehicle network, and more specifically, to a method and a device of providing an alarm and storing a log by changing a setting based on information about an attack on a vehicle network.

### 2. Related Art

As vehicles are equipped with various functions and connected to many electronic devices, the use of existing networks used in vehicles, such as a controller area network (CAN), a local interconnect network (LIN), FlexRay, and media oriented system transport (MOST), has a limitation, and thus in order to supplement the limitations, Ethernet is beginning to be used in vehicles. However, with the introduction of Ethernet into vehicles, the possibility of external hacking or attacks has increased. Such attacks on vehicle networks may have serious implications for occupant safety, which requires separate security technologies.

However, not all communications in vehicles are converted to Ethernet.

Since existing techniques for detecting attacks on vehicle networks are technologies that are targeted at legacy networks (mainly targeted at CANs), it is difficult to apply existing technologies to vehicles in which Ethernet-based multi-domains are mixed. In addition, attack detection technology in general Ethernet does not reflect the characteristics of vehicles and thus are difficult to apply directly to vehicles.

### SUMMARY

The present disclosure is directed to providing a method and a device for notifying a user of an attack when the attack occurs on a vehicle network and storing a log of the attack.

The present disclosure is also directed to reducing unnecessary alarms and log records by changing alarms and log records according to attacks occurring on a vehicle network.

According to an aspect of the present disclosure, a method provides an alarm and stores a log based on detecting an attack on a vehicle network of an electronic device. The method includes: detecting or determining an attack on a vehicle network; when the attack is detected or based on the attacking being detected or determined, determining whether the attack continues for a first period of time; when the attack continues for the first period of time or based on the attack continuing for the first period of time, storing a log just before a second period of time; when the attack continues for the first period of time or based on the attack continuing for the first period of time, providing an alarm; after the alarm, determining whether the attack continues for a third period of time; when the attack continues for the third period of time or based on the attack continuing for the third period of time, providing the alarm again; when the attack does not continue for the third period of time or based on the attack not continuing for the third period of time, determining that the attack is ended; determining whether an end of the attack continues for a fourth period of time; and when it is determined that the attack is ended or based on a determination that the attack is ended, storing the log from an attack stop time point, at which the attack is ended, to a fifth period of time. The log is stored from a log start time point, which is earlier than an attack detection time point, to a time point when the fifth period of time has elapsed after the attack is ended.

The method may further include identifying or determining information about the attack, and the first to fifth period of times may be determined based on the information about the attack.

The first period of time may be equal to the fourth period of time.

The second period of time may be equal to the fifth period of time.

The information about the attack may include information about at least one of an electronic control unit, an amount of data on a network bus, or a response.

The log may be stored in an area of a memory based on the information about the attack on the vehicle network.

The method may include, checking an area of a memory for storing the log; and when the area of the memory is insufficient or does not satisfy a condition to store the log (or based on the area of the memory being insufficient or not satisfying a condition to store the log), storing the log in a different area of the memory having a low priority based on a priority in the information about the attack on the vehicle network.

The vehicle network may be a vehicle Ethernet network, and information stored as the log may be determined based on a type of a vehicle including the electronic device and a type of the attack.

The first to fifth period of times may be values that are predetermined and stored in a memory.

The log start time point may be earlier than the attack detection time point by an amount of time obtained by subtracting the first period of time from the second period of time.

According to another aspect of the present disclosure, an electronic device includes a memory, a communication module, and a processor. The processor: detects or determines an attack on a vehicle network; when the attack is detected or determined (or based on the attack being detected of determined), determines whether the attack continues for a first period of time; when the attack continues for the first period of time or based on the attack continuing for the first period of time, stores a log just before a second period of time; when the attack continues for the first period of time or based on the attack continuing for the first period of time, provides an alarm; after the alarm, determines whether the attack continues for a third period of time; when the attack continues for the third period of time or based on the attack continuing for the third period of time, provides the alarm again; when the attack does not continue for the third period of time or based on the attack not continuing for the third period of time, determines that the attack is ended; determines whether the end of the attack continues for a fourth period of time; and when it is determined that the attack is ended or based on a determination that the attack is ended, stores the log from an attack stop time point at which the attack is ended to a fifth period of time. The log is stored from a log start time point, which is earlier than an attack detection time point, to a time point when the fifth period of time has elapsed after the attack is ended.

The processor may identify or determine information about the attack, and the first to fifth period of times may be determined based on the information about the attack. The first period of time may be equal to the fourth period of time.

The second period of time may be equal to the fifth period of time.

The information about the attack may include information about at least one of an electronic control unit, an amount of data on a network bus, or a response.

The log may be stored in an area of a memory based on the information about the attack on the vehicle network.

The processor may check an area of the memory for storing the log. When the area of the memory is insufficient or does not satisfy a condition to store the log (or based on the area of the memory being insufficient or not satisfying a condition to store the log), the processor may store the log in a different area of the memory having a low priority based on a priority in the information about the attack on the vehicle network.

The vehicle network may be a vehicle Ethernet network, and information stored as the log may be determined according to or based on a type of a vehicle including the electronic device and a type of the attack.

The first to fifth period of times may be stored in the memory as predetermined values.

The log start time point may be earlier than the attack detection time point by an amount of time obtained by subtracting the first period of time from the second period of time.

### BRIEF DESCRIPTION OF THE DRAWINGS

The above and other objects, features and advantages of the present disclosure should become more apparent to those of ordinary skill in the art by describing embodiments thereof in detail with reference to the accompanying drawings, in which:

FIG. 1A is a diagram illustrating an example of a network of a vehicle to which Ethernet is partially applied according to one embodiment of the present disclosure;

FIG. 1B is a diagram illustrating an example of a network of a vehicle to which Ethernet is applied as a backbone network according to one embodiment of the present disclosure;

FIG. 2 is a diagram illustrating, when an attack on a vehicle network is detected in terms of time, an alarm timing for providing notification of the attack and a timing for recording a log related to the attack according to one embodiment of the present disclosure;

FIG. 3 is a flowchart of a method in which an electronic device detects an attack on a vehicle network, provides an alarm according to the attack, and stores a log according to one embodiment of the present disclosure; and

FIG. 4 is a block diagram of a device that provides an alarm according to detection of an attack on a vehicle network and stores a log according to one embodiment of the present disclosure.

### DETAILED DESCRIPTION

Hereinafter, embodiments of the present disclosure are described with reference to the accompanying drawings.

However, the technical spirit of the present disclosure is not limited to some embodiments which are described and may be realized using various other embodiments, and at least one component of embodiments may be selectively coupled, substituted, and used to realize the technical spirit within the range of the technical spirit of the present disclosure.

In addition, unless clearly and specifically defined otherwise by context, all terms (including technical and scientific terms) used herein can be interpreted as having customary meanings to those having ordinary skill in the art, and meanings of generally used terms, such as those defined in commonly used dictionaries, should be interpreted by considering contextual meanings of the related technology.

In addition, the terms used in embodiments of the present disclosure are for the purpose of describing embodiments and are not intended to limit the present disclosure.

In the present specification, unless clearly indicated otherwise by the context, singular forms include the plural forms thereof. In a case in which “at least one (or one or more) among A, B, and C” is described, this may include at least one combination among all combinations which can be combined with A, B, and C. In addition, in the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

In addition, in descriptions of components of the present disclosure, terms such as first, second, A, B, (a), and (b) can be used.

The terms are only to distinguish one element from another element, and an essence, order, and the like of the element are not limited by the terms.

In addition, it should be understood that, when an element is referred to as being “connected or coupled” to another element, such a description may include both of a case in which the element is directly connected or coupled to another element and a case in which the element is connected or coupled to another element with still another element disposed therebetween.

In addition, in a case in which any one element is described as being formed or disposed “on or under” another element, such a description includes both cases in which the two elements are formed or disposed in direct contact with each other and in which one or more other elements are interposed between the two elements. In addition, when one element is described as being disposed “on or under” another element, such a description may include a case in which the one element is disposed at an upper side or a lower side with respect to another element.

In addition, when a component, processor, device, element, apparatus, or the like of the present disclosure is described as having a purpose or performing an operation, function, or the like, the component, processor, device, element, apparatus, or the like should be considered herein as being “configured to” meet that purpose or to perform that operation or function.

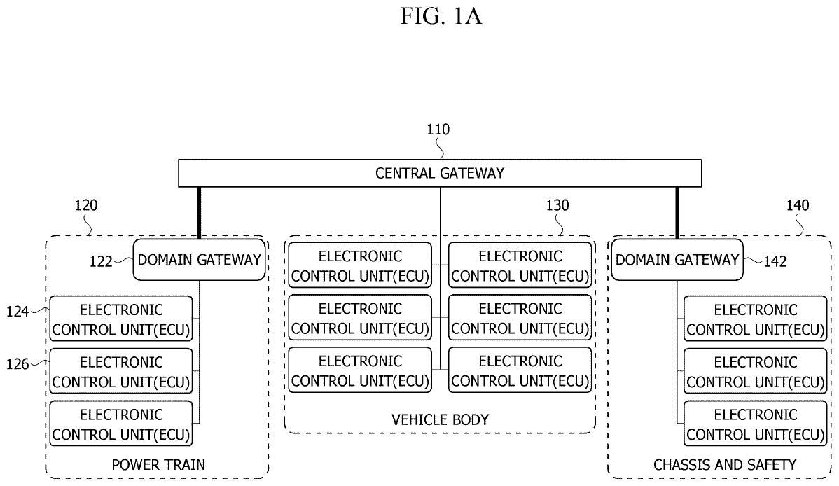

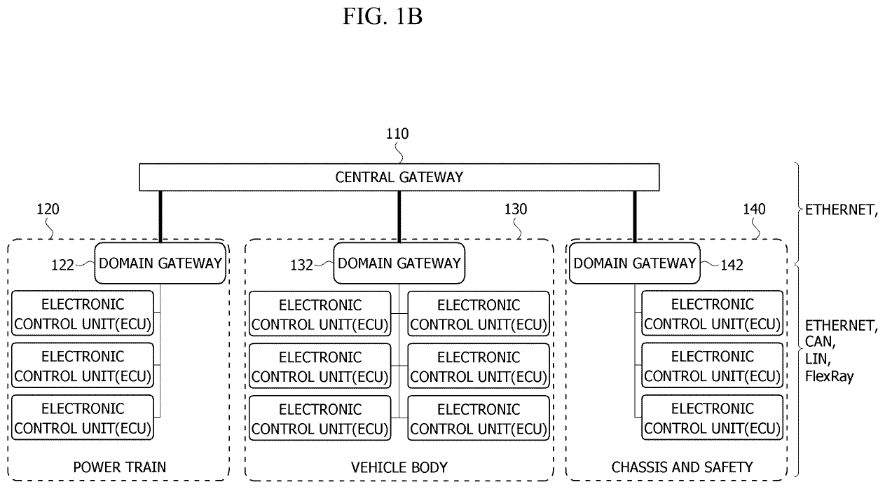

FIG. 1A is a diagram illustrating an example of a network of a vehicle to which Ethernet is partially applied, and FIG. 1B is a diagram illustrating an example of a network of a vehicle to which Ethernet is applied as a backbone network.

Networks such as a controller area network (CAN), FlexRay, and a local interconnect network (LIN) are not suitable for processing large amounts of data in terms of bandwidth or size, and thus it may be desirable for electronic control units (ECUs) to operate in a hierarchical structure based on domains. Ethernet may have a wide bandwidth and accommodate a plurality of domains and thus may be suitable for use as a backbone bus in a vehicle network.

In FIGS. 1A and 1B, domains are classified according to the functions of a vehicle to illustrate a power train 120, a body 130, and a chassis and safety 140, but autonomous driving, infotainment, or the like may be further included. In addition, in FIGS. 1A and 1B, the domains are classified according to the functions of the vehicle, but the domains may also be classified according to locations in the vehicle.

First, an example in which an Ethernet network is applied to a portion of a vehicle network is described with reference to FIG. 1A. Referring to FIG. 1A, an Ethernet network is applied to domains of the power train 120 and the chassis and safety 140. Components (for example, ECUs) included in the domains of the power train 120 and the chassis and safety 140 may be connected to the domain gateways 122 and 142 of the domains, in which the components are included, using communication methods thereof. For example, when an ECU 124 included in the domain of the power train 120 supports a CAN communication method, the ECU 124 may be connected to the domain gateway 122 of the domain of the power train 120 using the CAN communication method. In addition, when another ECU 126 included in the domain of the power train 120 supports a LIN communication method, the other ECU 126 may be connected to the domain gateway 122 of the domain of the power train 120 using the LIN communication method. The domain gateway 122 or 142 of each domain may be connected to a central gateway 110. The domain gateways 122 and 142 and the central gateway 110 may transmit or receive data through Ethernet communication. On the other hand, since an Ethernet network is not applied to ECUs included in a domain of a vehicle body 130, each ECU in the domain of the vehicle body 130 may be directly connected to the central gateway 110. The ECUs included in the domain of the vehicle body 130 may be connected to the central gateway 110 through communication methods thereof to transmit or receive data. When communicating with the domains of the power train 120 and the chassis and safety 140, the central gateway 110 uses the Ethernet to communicate with the domain gateways 122 and 142 of the domains. However, when communicating with the domain of the vehicle body 130, the central gateway 110 should communicate directly with each ECU in the domain of the vehicle body 130, and thus communication may be performed using a communication method supported by each ECU.

In one embodiment, an Ethernet network may be applied to only a portion of a vehicle network for various reasons such as an increase in cost due to a purchase of equipment for Ethernet communication, a decrease in efficiency due to many domains, a risk of intrusion due to external threats, and a transitional stage.

Next, an example in which the Ethernet network is applied to the entirety of the vehicle network is described with reference to FIG. 1B. Referring to FIG. 1B, the Ethernet network is applied as the backbone network throughout the vehicle network. The Ethernet network may be constructed based on domains, and the entire network may be connected through the domains so that a configuration as shown in FIG. 1B may be referred to as a domain-centralized type. In the domain-centralized type, domain gateways 122, 132, and 142 representing domains may perform Ethernet communication with the central gateway 110. A domain gateway may communicate with ECUs included in a domain according to a communication method thereof. In other words, the domain gateway may receive data from the central gateway 110 through Ethernet communication, may change a format of the data according to a communication method of each ECU, and may transmit the data to each ECU. In addition, after the domain gateway receives data from each ECU according to each communication method, the domain gateway may convert a format of the data according to Ethernet communication and may transmit the data to the central gateway 110.

Hereinafter, a configuration and method for, when an attack is detected on a vehicle network, providing an alarm for providing notification of the attack and recording a log is described in detail.

In one embodiment, when a vehicle is started or powered on, an electronic device may monitor in real time whether an attack occurs on a vehicle network. The electronic device may be provided as a separate electronic device for providing an alarm and recording a log when an attack on the vehicle network is detected or may be any one of a domain gateway, a central gateway, and an ECU.

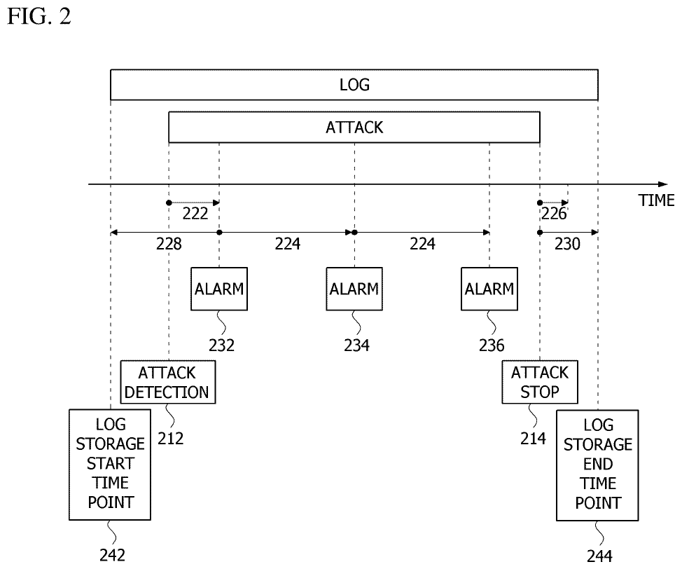

FIG. 2 is a diagram illustrating, when an attack on a vehicle network is detected in terms of time, an alarm timing for providing notification of the attack and a timing for recording a log related to the attack according to one embodiment of the present disclosure.

First, when the attack on the vehicle network is detected, the alarm timing for providing notification of the attack is described.

Referring to FIG. 2, when an attack 212 is detected on a vehicle network and continues for a first period of time 222, an alarm 232 may be provided. When the attack continues even after the alarm 232 is provided, alarms 234 and 236 may be provided at an interval of a second period of time 224. In one embodiment, the second period of time 224 may be twice the first period of time 222. Afterwards, when the attack on the vehicle network stops, and there is no attack for a third period of time 226 from a time point 214 at which the attack stops, the alarm may no longer be provided. In one embodiment, the first period of time 222 may be the same as the third period of time 226.

In one embodiment, the electronic device may manage an alarm using a flag internally. For example, the electronic device may set the flag to 1 when an attack is detected or determined and the alarm is provided or may set the flag to 0 when the attack stops and it is determined that the alarm does not need to be provided. The electronic device may use the flag to determine whether the attack continues. The electronic device may provide the alarm only by checking the flag.

In one embodiment, the electronic device may provide an alarm when an attack is detected on the vehicle network and also may store a log related to the detected attack. The information stored as the log may vary according to types of vehicles that include the electronic device. In addition, the information stored as the log may vary according to types of attacks detected by the electronic device (for example, an ECU removal attack, a bus flooding attack, and a replay attack).

Next, when the attack on the vehicle network is detected, the timing for recording the log related to the attack is described.

Referring again to FIG. 2, at a time point at which an attack is detected and the first alarm 232 is provided, the log is stored before a fourth period of time 228. In other words, a log storage start time point 242 may be a time point that is earlier than a time point, at which the first alarm 232 is provided, by the fourth period of time 228. Afterwards, the log may be stored until a time point when a fifth period of time 230 has elapsed after an attack stops 214.

In one embodiment, the fourth period of time 228 may be the same as the fifth period of time 230.

In one embodiment, the first to fifth period of times, a size of a memory (or a buffer) for storing the log, and at least a portion of information stored as the log may be determined based on an identified attack. When an attack is detected on the vehicle network, the electronic device may identify information about the attack.

The first to fifth period of times referred to in FIG. 2 are merely indicated in the order in which the first to fifth period of times are described and do not have any specific meaning. The first to fifth period of times may be referred to differently in other drawings.

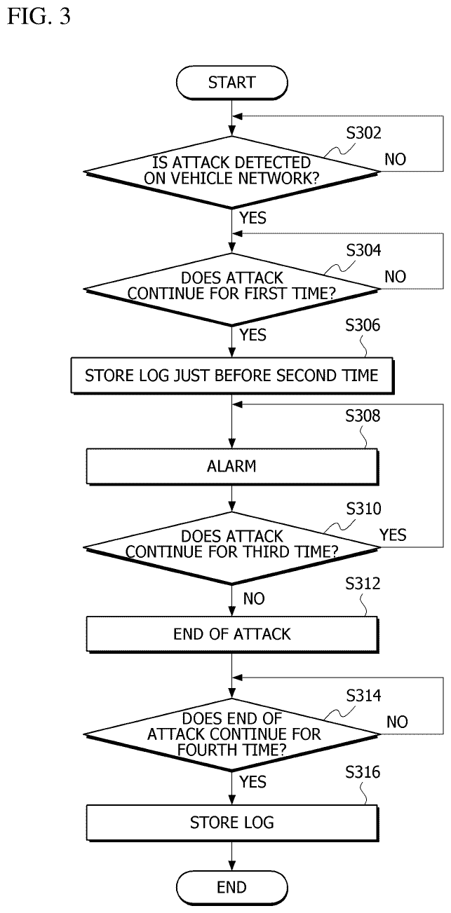

FIG. 3 is a flowchart of a method in which an electronic device detects an attack on a vehicle network, provides an alarm according to the attack, and stores a log according to one embodiment of the present disclosure.

In one embodiment, as described with reference to FIG. 2, the electronic device may be a separate device configured to, when an attack on a vehicle network is detected or determined, provide an alarm for providing notification of the attack and record a log or may be any one of a domain gateway, a central gateway, and an ECU.

Referring to FIG. 3, the electronic device may detect or determine whether an attack occurs on the vehicle network (S302). When a vehicle is started or powered on, the electronic device may monitor in real time whether the attack occurs on the vehicle network. The vehicle network may be a vehicle Ethernet network.

When it is determined that the attack occurs on the vehicle network, the electronic device may determine whether the attack continues for a first period of time (S304). It may be incorrectly determined that the attack occurs, and thus the electronic device may determine that the attack occurs after determining whether the attack continues for the first period of time. According to one embodiment, the first period of time may be a predetermined period of time. For example, the first period of time may be predetermined to the same value irrespective of types of attacks. Alternatively, the first period of time may be predetermined to different values according to types of attacks. According to one embodiment, the first period of time may be predetermined and stored in a memory or the like, and the electronic device may retrieve the first period of time from the memory or the like when an attack is detected.

According to one embodiment, when it is determined that the attack occurs on the vehicle network, the electronic device may identify the detected attack. For example, when it is confirmed that data is transmitted from an electronic device with an IP (internet protocol) rather than an IP whitelist used in a corresponding vehicle, the electronic device may determine that the attack is an ECU removal attack. When it is confirmed that a transmission amount of data is greater than or equal to a threshold value, the electronic device may determine that the attach is a bus flooding attack. The threshold value may vary according to a protocol. In addition, when it is determined that the same data is transmitted again for a set time, the electronic device may determine that the attack is a replay attack. According to one embodiment, the electronic device may determine the first period of time based on an identified attack. For example, when a detected attack is identified as a high priority attack such as an ECU removal attack, the first period of time may be set to be short, and when the attack is identified as a low priority attack such as a replay attack, the first period of time may be set to be long (i.e., longer than the time period for a high priority attack). In addition, the first period of time may be determined in further consideration of a time required for the electronic device to accurately determine an attack on the vehicle network. When an amount of data transmitted or received through the vehicle network increases, the electronic device may determine the first period of time in consideration of a time appropriate for determining whether data increases due to actual need or whether unnecessary data increases due to an attack. Alternatively, when the detected attack is the ECU removal attack, the electronic device may determine the first period of time in consideration of a time required to determine an IP of a device that transmits data. According to another embodiment, the electronic device may retrieve the first period of time stored in the memory or the like based on the identified attack.

According to one embodiment, when information about the detected attack is identified, the electronic device may determine whether the attack continues for the first period of time based on the identified attack. For example, when the detected attack is a bus flooding attack that transmits a large amount of unnecessary data in a certain time, the electronic device may check whether the attack continues by checking an amount of data transmitted in the first period of time. Alternatively, when the detected attack is a replay attack that transmits the same data again, the electronic device may check whether the attack continues by checking the number of times by which the same data is transmitted for the first period of time. Alternatively, when the detected attack is an ECU removal attack in which an electronic device with an IP not stored in an IP whitelist transmits data, the electronic device may check whether a device, which is on an IP whitelist to previously transmit data, transmits data for the first period of time.

When it is determined that the attack continues for the first period of time, the electronic device may first store a log just before a second period of time in the memory (S306). According to one embodiment, in the memory, areas in which logs are to be stored may be separated according to types of attacks. When there is not enough space to store logs in the memory, the electronic device may erase an area in which a low priority log is stored and may store a newly generated log.

According to embodiment, at least a portion of information about the detected attack to be stored in a log at the second period of time may be predetermined. According to another embodiment, the electronic device may determine at least a portion of the capacity of the memory, which is to store the log, during the second period of time based on the information about the identified attack. According to still another embodiment, the second period of time may be determined based on the first period of time. For example, when the attack is the ECU removal attack, the second period of time may be determined to be the first period of time+1 (i.e., plus one predefined value of time), and when the attack is the bus flooding attack, the second period of time may be determined to be the first period of time× 3/2 (i.e., one and a half times longer than the first period of time). In addition, when the attack is the replay attack, the second period of time may be determined to be the first period of time×2 (i.e., twice as long as the first period of time).

When it is determined that the attack on the vehicle network continues for the first period of time, the electronic device may provide an alarm (S308). According to one embodiment, the alarm may be provided to a user. For example, the alarm may be displayed on a dashboard in the vehicle or may be audibly provided to the user through a speaker. According to one embodiment, the alarm may also be transmitted to other electronic devices connected to the vehicle (for example, a server and a smartphone of a user).

The electronic device may determine whether the attack continues for a third period of time (S310). According to one embodiment, the third period of time may be a time for determining whether the detected attack continues. The attack on the vehicle network may include an attack that transmits data without stop, but there may be an interval between attacks due to a data processing time or a data transmitting time. The interval between the attacks may also vary according to types of attacks. Therefore, the electronic device may monitor and determine whether the attack continues for a time for determining whether the attack is continues, i.e., for the third period of time. Alternatively, similar to the first period of time, the third period of time may be a time predetermined differently irrespectively of types of attacks or according to types of attacks. When the third period of time is a value that is predetermined and stored in the memory or the like, the electronic device may retrieve the third period of time from the memory when necessary.

According to one embodiment, the third period of time may be twice the first period of time.

According to one embodiment, when the attack continues for the third period of time, the electronic device may provide an alarm again as described above (S308).

According to embodiment, when the attack does not continue for the third period of time, the electronic device may determine that the attack is ended (S312).

When a state in which the attack on the vehicle network is ended continues for a fourth period of time, the electronic device may determine that the attack is ended (S314). According to one embodiment, the fourth period of time may be a predetermined period of time like other times. For example, the fourth period of time may be a time predetermined differently irrespectively of types of attacks or according to types of attacks. When the fourth period of time is a predetermined time, the fourth period of time may be stored in the memory or the like, and the electronic device may retrieve the fourth period of time from the memory when necessary. According to another embodiment, the fourth period of time may be determined based on an identified attack. The fourth period of time may be determined differently according to types of attacks or may be determined in further consideration of a time required to accurately determine whether the attack on the vehicle network is ended.

When the electronic device determines that the attack on the vehicle network is ended, it is possible to store a log from a time point at which the attack is ended to a time point when a fifth period of time has elapsed (S316). According to one embodiment, when there is not enough space to store logs in the memory, the electronic device may erase an area in which a low priority log is stored and may store a newly generated log.

According to one embodiment, as described above, the fifth period of time period may be set based on information about an attack identified by the electronic device. Since the electronic device may perform recovery for a detected attack, in order to store a log, even when an attack is stopped, a log after a certain time may be stored. According to embodiment, the fifth period of time may be the same as the second period of time.

For reference, the first to fifth period of times referred to in FIGS. 2 and 3 are merely indicated in the order in which the first to fifth period of times are described. The second period of time in FIG. 2 and the second period of time in FIG. 3 may be different period of times.

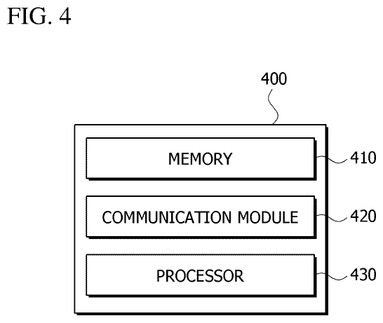

FIG. 4 is a block diagram of an electronic device that provides an alarm and stores a log according to detection of an attack on a vehicle network according to one embodiment of the present disclosure.

Referring to FIG. 4, an electronic device 400 may include a memory 410, a communication module 420, and a processor 430.

The memory 410 may be electrically connected to the processor 430 and may store necessary information. For example, the first to fifth period of times described with reference to FIG. 3 may be predetermined and stored in the memory 410. In addition, the memory 410 may store commands for allowing the processor 430 to detect the attack on the vehicle network, provide an alarm according to the detection, and store the log.

According to one embodiment, a partial area of the memory 410 may be an area for storing the log according to detection of the attack. In the memory 410, areas capable of storing logs may be separated according to types of attacks.

According to one embodiment, when there is not enough space to store data in the memory 410, an area in which a log for a low priority attack is stored may be first erased.

In order to detect the attack on the vehicle network, the communication module 420 may be connected to the vehicle network to transmit or receive data. According to one embodiment, the vehicle network may be a vehicle Ethernet network, and the communication module 420 may support the vehicle Ethernet network.

The processor 430 may be electrically connected to the memory 410 and the communication module 420 to perform the overall functions of the electronic device 400. For example, the processor 430 may detect whether the attack occurs on the vehicle network through the communication module 420, and when it is determined that the attack occurs on the vehicle network, the processor 430 may determine whether the attack continues for the first period of time. When it is determined that the attack on the vehicle network continues for the first period of time, the processor 430 may first store a log just before the second period of time in the memory 410 and may provide an alarm. The processor 430 may determine whether the attack on the vehicle network continues for the third period of time, and when it is determined that the attack on the vehicle network continues for the third period of time, the processor 430 may further provide an alarm. When the attack on the vehicle network does not continue for the third period of time, the processor 430 may determine that the attack is ended and may further determine whether a state in which the attack is ended continues for the fourth period of time. When the processor 430 determines that the attack on the vehicle network is ended, it is possible to store a log from a time point at which the attack is ended to a time point when the fifth period of time has elapsed.

According to one embodiment, when the attack on the vehicle network is detected, the processor 430 may provide an alarm every certain time from when a set time has elapsed after the attack is detected. However, the processor 430 may no longer provide an alarm when the attack is ended and a set time has elapsed.

According to one embodiment, when the attack on the vehicle network is detected and the alarm is provided, the processor 430 may store a log in the memory 410 before a certain time before the alarm is provided. However, the processor 430 may store the log in the memory 410 until a time point when a certain time has passed after the attack is ended. When there is not enough memory to store logs, the processor 430 may erase a portion or the entirety of the memory 410 in which a low priority log for a detected attack is stored and may store a newly generated log.

According to embodiments of the present disclosure, alarms and log records can be changed according to an attack that occurs on a vehicle network.

In addition, according to embodiments of the present disclosure, resources of a vehicle may be efficiently used by changing log records according to an attack that occurs on a vehicle network.

While the present disclosure has been described with reference to embodiments thereof, this is merely an example and is not intended to limit the present disclosure, and those having ordinary skill in the art to which the present disclosure pertains should be able to understand that various modifications and applications not exemplified above are possible without departing from the essential characteristics of the present embodiments. For example, each component specifically shown in embodiments may be implemented by modification. In addition, differences related to the modifications and applications should be construed as being included in the scope of the present disclosure defined in the appended claims.

What is claimed is:

1. A method comprising:
determining an attack on a vehicle network;
determining whether the attack continues for a first period of time based on the attack being determined;
based on the attack continuing for the first period of time, storing a log before a second period of time;
based on the attack continuing for the first period of time, providing an alarm;
after the alarm, determining whether the attack continues for a third period of time;
based on the attack continuing for the third period of time, providing the alarm again;
based on the attack not continuing for the third period of time, determining that the attack is ended;
determining whether an end of the attack continues for a fourth period of time; and
based on a determination that the attack is ended, storing the log from an attack stop time point at which the attack is ended to a fifth period of time,
wherein the log is stored from a log start time point, which is earlier than an attack detection time point, to a time point when the fifth period of time has elapsed after the attack is ended.

2. The method of claim 1, wherein the first period of time is equal to the fourth period of time.

3. The method of claim 1, wherein the second period of time is equal to the fifth period of time.

4. The method of claim 1, further comprising determining information about the attack,
wherein the first to fifth period of times are determined based on the information about the attack.

5. The method of claim 4, wherein the information about the attack includes information about at least one of an electronic control unit, an amount of data on a network bus, or a response.

6. The method of claim 4, wherein the log is stored in an area of a memory based on the information about the attack on the vehicle network.

7. The method of claim 4, further comprising:
checking an area of a memory for storing the log; and
based on the area of the memory not satisfying a condition to store the log, storing the log in a different area of the memory having a low priority based on a priority in the information about the attack on the vehicle network.

8. The method of claim 1, wherein the vehicle network is a vehicle Ethernet network, and
information stored as the log is determined based on a type of a vehicle including an electronic device and a type of the attack.

9. The method of claim 1, wherein the first to fifth period of times are values that are predetermined and stored in a memory.

10. The method of claim 1, wherein the log start time point is earlier than the attack detection time point by an amount of time obtained by subtracting the first period of time from the second period of time.

11. An electronic device comprising:
a memory;
a communication module; and
a processor,
wherein the processor is configured to
detect an attack on a vehicle network,
based on the attack being determined, determine whether the attack continues for a first period of time,
based on the attack continuing for the first period of time, store a log before a second period of time,
based on the attack continuing for the first period of time, provide an alarm,
after the alarm, determine whether the attack continues for a third period of time,
based on the attack continuing for the third period of time, provide the alarm again,
based on the attack not continuing for the third period of time, determine that the attack is ended,
determine whether an end of the attack continues for a fourth period of time, and
based on a determination that the attack is ended, store the log from an attack stop time point at which the attack is ended to a fifth period of time,
wherein the log is stored from a log start time point, which is earlier than an attack detection time point, to a time point when the fifth period of time has elapsed after the attack is ended.

12. The electronic device of claim 11, wherein the first period of time is equal to the fourth period of time.

13. The electronic device of claim 11, wherein the second period of time is equal to the fifth period of time.

14. The electronic device of claim 11, wherein the processor is further configured to determine information about the attack, and
wherein the first to fifth period of times are determined based on the information about the attack.

15. The electronic device of claim 14, wherein the information about the attack includes information about at least one of an electronic control unit, an amount of data on a network bus, or a response.

16. The electronic device of claim 14, wherein the log is stored in an area of a memory based on the information about the attack on the vehicle network.

17. The electronic device of claim 14, wherein, the processor is further configured to:
check an area of the memory for storing the log, and
based on the area of the memory not satisfying a condition to store the log, store the log in a different area of the memory having a low priority based on a priority in the information about the attack on the vehicle network.

18. The electronic device of claim 11, wherein the vehicle network is a vehicle Ethernet network, and
information stored as the log is determined based on a type of a vehicle including the electronic device and a type of the attack.

19. The electronic device of claim 11, wherein the first to fifth period of times are stored in the memory as predetermined values.

20. The electronic device of claim 11, wherein the log start time point is earlier than the attack detection time point by an amount of time obtained by subtracting the first period of time from the second period of time.
